(19) United States
(12) Patent Application Publication
(10) Pub. No.: US 2023/0340684 A1
(43) Pub. Date: Oct. 26, 2023

(54) ELECTROLYTIC ADDITIVE MANUFACTURING SYSTEM

(71) Applicant: Seagate Technology LLC, Fremont, CA (US)

(72) Inventors: Thomas Young CHANG, Menlo Park, CA (US); Kim Yang LEE, Fremont, CA (US); Mark T. KIEF, Lakeville, MN (US); Riyan Alex MENDONSA, Minneapolis, MN (US); Brett R. HERDENDORF, Mound, MN (US)

(21) Appl. No.: 18/305,973

(22) Filed: Apr. 24, 2023

Related U.S. Application Data
(60) Provisional application No. 63/335,051, filed on Apr. 26, 2022.

(51) Int. Cl. C25D 1/00; B33Y 10/00

(52) U.S. Cl. CPC C25D 1/003; B33Y 10/00

(57) ABSTRACT

A method for depositing a material from a solution to a surface is provided. The method includes depositing, through a deposition channel of a material depositor, the solution in a rich state to the surface, wherein the solution in the rich state includes an initial concentration of the material, onto a surface, applying a predefined electrical output, by the material depositor, through the deposited solution to adhere the material to the surface, and to yield the solution in a depleted state wherein the solution in the depleted state contains a different concentration of the material from the rich solution, and removing, through a removal channel in the material depositor, the deposited solution in the depleted state. The material depositor includes a hydrophilic region defined by a hydrophilic surface through which the material depositor conducts the depositing and the removing and a hydrophobic barrier circumscribing the hydrophilic region.

### CROSS-REFERENCE TO RELATED APPLICATIONS

The present application claims a benefit of priority to U.S. Provisional Patent Application No. 63/335,051, entitled “Electrolytic Additive Manufacturing System” and filed on Apr. 26, 2022. This application is incorporated by reference for all that it discloses or teaches.

### BACKGROUND

Electroplating (also referred to as electrodeposition) encompasses a variety of processes that create a metal coating on a solid substrate through the reduction of cations of that metal using a direct electric current. Three-dimensional (3D) printing (also referred to herein as additive manufacturing (AM)) refers to the construction of a 3D object from a computer-aided design (CAD) generated or otherwise obtained digital 3D model.

Additive manufacturing techniques for electroplating present significant design challenges. Using metal powder with sintering is often slow, expensive due to the use of high-power lasers, and complicated when depositing magnetic materials. Electrolytic deposition systems may involve immersion in the electrolytic solution, and changing to a different electrolyte solution may require removing the solution in which the substrate is immersed and replacing it with the different electrolyte solution. In systems without immersion, it may be difficult to maintain a meniscus to contain the fluid and ensure the fluid is removed by a material depositor that deposited the fluid.

### SUMMARY

The described technology provides a method for depositing a material from a solution to a surface. The method includes depositing, through a deposition channel of a material depositor, the solution in a rich state to the surface, wherein the solution in the rich state includes an initial concentration of the material, onto a surface, applying a predefined electrical output, by the material depositor, through the deposited solution to adhere the material to the surface, and to yield the solution in a depleted state wherein the solution in the depleted state contains a different concentration of the material from the rich solution, and removing, through a removal channel in the material depositor, the deposited solution in the depleted state. The material depositor includes a hydrophilic region including a hydrophilic surface, including gaps through which the material depositor conducts the depositing and the removing and a hydrophobic barrier circumscribing the hydrophilic region.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTION OF THE FIGURES

FIG. 1 illustrates an example additive manufacturing system.

FIG. 2 illustrates an implementation of a material depositor system.

FIG. 3 illustrates cross-sectional perspective views of examples of implementations of material depositors.

FIG. 4 illustrates an example of a magneto-mechanical flexure switch assembly, the components of which may be produced by an additive manufacturing system.

FIG. 5 illustrates example operations for operating an additive manufacturing system.

FIG. 6 illustrates an example computing device for implementing the features and operations of the described technology.

### DETAILED DESCRIPTION

Additive manufacturing systems provide convenient and dynamic platforms for printing metallic and/or electromagnetic materials that other additive manufacturing systems cannot. However, many of the systems lack dynamicity for producing precision electroplating for computer hardware applications. For example, precision microcircuitry may require the deposition of materials from solutions (e.g., electrolyte solutions) at the microscale or even the nanoscale. In solution-based additive manufacturing systems that require micro-scale or nanoscale precision for printing microcircuits or circuit elements, maintaining a meniscus in a precise location may present significant challenges. A failure in precision can cause electrical shorts or other errant electromagnetic anomalies. Also, some systems make it difficult to deposit more than one material.

The presently disclosed technology may allow for the precise deposition of metallic and/or electromagnetic materials to a substrate. In an implementation, a material depositor (e.g., a three-dimensional print head) of an additive manufacturing system includes a hydrophilic region at least partially including a hydrophilic surface or hydrophilic portions that is substantially circumscribed by a hydrophobic barrier. The arrangement of the hydrophilic region within the hydrophobic barrier may help to maintain a meniscus of solution deposited by the material depositor to a target surface.

In implementations, the material depositor may include deposition channels to deposit a solution to a target surface. The material depositor may include an electrode to apply a predefined electrical output through the solution to cause a material in the solution to deposit to the target surface. The target surface may be maintained at a different potential from the predefined electrical output (e.g., at ground potential) in order to provide an electrical potential difference that drives adherence of the material to the target surface. The solution, when first deposited, may be rich in the material. When the solution is removed, some of the material will have been deposited on the target surface, depleting the concentration of the material in the solution. The solution in the depleted state may be removed from the target surface using a removal channel in the material depositor. Between the deposition and the removal, the solution may be maintained within a meniscus composed of the solution between the material depositor and the target surface. By depositing and removing the solution, the additive manufacturing system can replenish the supply of the solution without immersing the target surface in a bath of the solution.

In implementations, an electrode of the material depositor may be configured to apply one or more predefined electrical outputs. In implementations, the predefined electrical output could include one or more of predefined voltages, currents, and/or voltage or current pulse distributions (e.g., steps or ramps in currents or voltages) that may be preconfigured based on design specifications of the material depositor to adhere at least one material in the solution to the target surface. In implementations, the material depositor is configured to apply a first predefined electrical output to first deposit a first material from the solution onto the target surface and apply a second predefined electrical output to then deposit a second material from the solution onto the target surface. The material depositor may additionally or alternatively have separate fluid channels to deposit different solutions from different sources, allowing simultaneous and/or sequential deposition of different materials from different solutions. Alternatively, the material depositor may have only one common fluid channel for receiving one solution at a time.

Various configurations of the deposition channels and the removal channels of the material depositor are contemplated. For example, in an implementation, a row of deposition channels can be positioned adjacent to and/or substantially parallel with a row of removal channels. The rows may be aligned or may be staggered with respect to the individual channels. The relative numbers of deposition and removal channels and/or relative numbers of rows of deposition and removal channels may differ as well. For example, there may be fewer or more deposition channels than removal channels. The cross-sectional areas of the deposition and removal channels may differ. For example, the removal channels may have larger cross-sectional areas than those of the deposition channels. In an implementation, the removal channels may be positioned medially relative to the deposition channels in the material depositor in order to provide a flow direction that encourages the solution to remain within a meniscus between the material depositor and the target surface.

The additive manufacturing system may include one or more pressure application devices adapted to apply a predefined pressure to one or more of supply the solution to the material depositor to deposit the solution through a deposition channel to a target surface and/or remove the solution from the target surface through a removal channel. The predefined pressure may account for the properties of the material depositor (e.g., for fluid mechanical considerations), the surface, and/or the solution to provide pressure that maintains the solution within a solution meniscus.

The additive manufacturing system may include a controller that controls the functions of the additive manufacturing system and its material depositor. The controller may communicate with one or more sensors to determine a position of the material depositor relative to the target surface and/or to a base of the additive manufacturing system on which the element with the target surface is located. In implementations, the material depositor may include a sensor in communication with the controller for one or more of determining a relative location of the material depositor and/or determining a magnitude, a thickness, a location, an electrical responsiveness, a magnetic responsiveness, and/or a presence of the material deposited by the material depositor on the target surface.

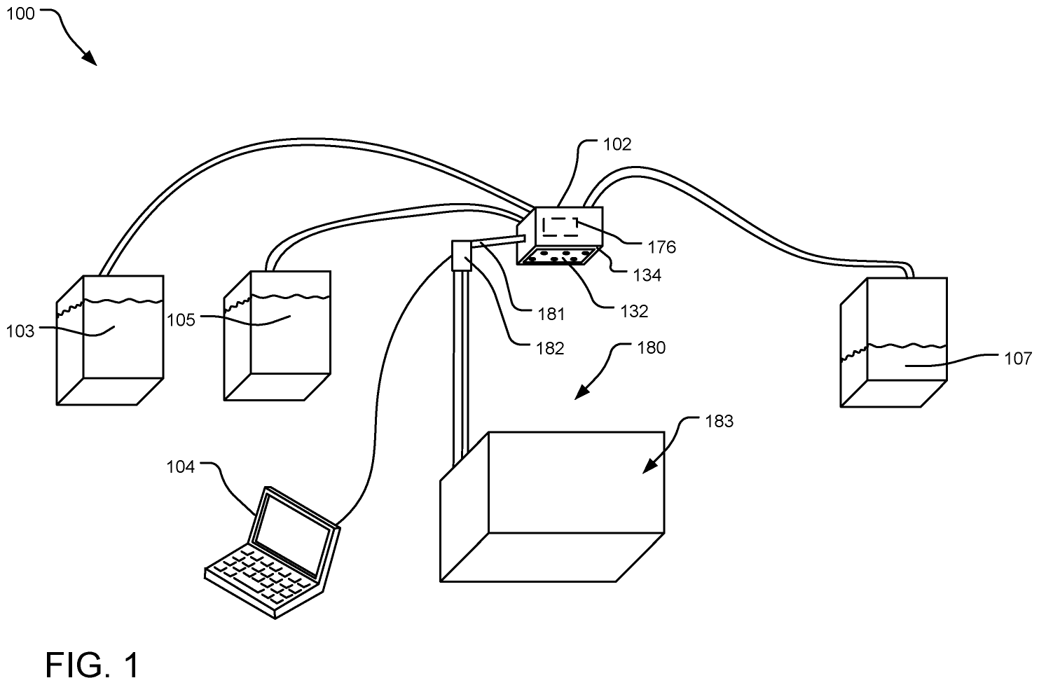

FIG. 1 illustrates an example additive manufacturing system 100. The system includes an additive manufacturing device 180 that includes an actuated arm 181, a controller 182, a base 183, and a material depositor 102. The controller 182 may control the motion of the actuated arm 181 to position the material depositor to a location relative to a target surface located on an element (not illustrated) placed on the base 183 of the additive manufacturing device 180. The controller 182 may be in electronic communication with a computing device 104 (e.g., external of the controller 182) to receive instructions and/or to present data from the controller 182. The controller 182 may include additive manufacturing protocols to execute operations of the additive manufacturing systems disclosed herein.

The additive manufacturing system 100 includes a first source reservoir 103, a second source reservoir 105, and a disposal reservoir 107. Implementations are also contemplated in which the disposal reservoir 107 is operable to recycle the solution by one or more of recharging the solution with material to deposit and/or returning the solution to one or more of the first source reservoir 103 and the second source reservoir 105. In an implementation, the first source reservoir 103 contains a solution (e.g., an electrolyte solution) with a material (e.g., an electrolyte or other electrically or magnetically responsive material) for deposition on the target surface of the element. The second source reservoir 105 is optional and may contain the solution or a different solution. Implementations are contemplated in which one or more of the first source reservoir 103 and/or the second source reservoir 105 are directly coupled to or otherwise integrated with the material depositor 102.

The material depositor 102 may, based on instructions from the controller 182, deposit the solution provided by the first source reservoir 103 on the target surface. In implementations, the deposition channels are fed by a common feed source channel. In implementations in which the material depositor 102 is configured to load more than one electrolytic solution at a time, the material depositor 102 may include a common source feed channel for more than one of the solutions or separate common source feed channels for each of the solutions.

The pressure to transport the solution from the first source reservoir 103 to the material depositor 102 may be provided or facilitated by a pressure application device 176 (e.g., a pump). Although illustrated as a pressure application device 176 internal to the material depositor 102, implementations are contemplated in which the additive manufacturing system 100 includes more than one instance of the pressure application device 176 (e.g., a pump for one or more of each of the first source reservoir 103, the second source reservoir 105, and/or the disposal reservoir 107) and/or the pressure application device 176 is not integral to the material depositor 102.

At this stage, the solution may be in an initial rich state in which no material has yet been removed from the solution. The solution may be deposited by the material depositor 102 on a target surface via one or more deposition channels in communication with the common source feed channel. One or more electrodes of the material depositor 102 may apply a predefined electrical output to the solution while the solution is engaged with the target surface. The target surface may be provided with an electrical potential (or relative or absolute ground) that is different from or otherwise adapted to receive the predefined electrical output provided by the one or more electrodes. The potential difference may cause some of the material from the solution to deposit on the target surface, at least partially depleting the solution of the material deposited.

Implementations are considered in which the one or more electrodes may be adapted to apply more than one predefined electrical output. For example, the material depositor 102 may dispense a solution with more than one electrolyte, and the relative deposition and/or adherence of each of the more than one electrolyte can be controlled by the predefined electrical outputs applied (e.g., a predefined duration over which the application occurs, a predefined magnitude of current, a predefined magnitude of potential or voltage, and/or a predefined area over which the electrical output is applied). For example, in a solution with materials (e.g., electrolytes) A and B, applying a first predefined electrical output may deposit more A than B (or substantially no B at all) to a target surface, but applying a second predefined electrical output may deposit more B than A (or substantially no A at all) on a target surface. While the materials for the solution described herein are specified as electrolytes, any electrically reactive or responsive materials that are at least semi-soluble in solution are contemplated, such as ions, polarized materials, and the like.

In implementations, the material depositor 102 may be capable of receiving and separately dispensing through different deposition channels and/or at different times more than one solution, and electrodes of the material depositor 102 may be configured to apply different predefined electrical outputs to each of the solutions (e.g., by applying different predefined electrical outputs at electrodes adjacent to deposition channels that deposit the different solutions). The different predefined electrical outputs may also be applied for different durations depending on the kinetics of the additive manufacturing system 100.

The material depositor 102 may then remove the solution in a depleted state via a removal channel in the material depositor 102. The deposition and removal may be conducted in a preconfigured manner. For example, predefined pressures may be applied to channels within the material depositor 102 to ensure that a meniscus of the solution is maintained between the material depositor 102 and the target surface.

Portions of the deposition and removal processes may be conducted continuously and/or discretely. Predefined pressures to be applied to the solution in the additive manufacturing system 100 may be determined based on one or more of a predefined cohesion of the solution, a geometry of flow path for the solution through the material depositor 102, a predefined residence time for the solution on a hydrophilic surface, a predefined potential application duration, and/or a predefined distance between one of the at least one deposition channel and one of the at least one removal channel.

In implementations, the material depositor 102 includes a hydrophilic region 132 at least partially defined by or including a hydrophilic surface or other hydrophilic portions. The hydrophilic region 132 includes gaps with outlets of the deposition channels and the removal channels. The material depositor 102 further includes a hydrophobic barrier 134 that substantially circumscribes the hydrophilic region 132. As used herein, substantially circumscribes means that a portion of the perimeter of the hydrophilic region 132 is circumscribed by the hydrophobic barrier 134. The portion of the perimeter may amount to more than 30%, 35%, 40%, 45%, 50%, 55%, 60%, 65%, 70%, 75%, 80%, 85%, 90%, or 95% of the perimeter. The portion of the perimeter can also be described as surrounding three sides, two opposite sides, a complete side and parts of two sides adjacent to the complete side, portions of all sides, portions of three sides, portions of two sides, and/or the like. As illustrated, the perimeter of the hydrophilic region 132 is entirely circumscribed by the hydrophobic barrier 134.

The solution (e.g., in the depleted state) is removed via the one or more removal channels to one or more common removal channels in the material depositor 102. The one or more removal channels may be adapted to collect the solution removed from the target surface by the material depositor and output the collected solution from the material depositor 102. In the illustrated example, the one or more common removal channels are in fluid communication with the disposal reservoir 107 to dispose of the removed solution in the disposal reservoir 107 (e.g., by a common removal channel).

The solution may be preformulated to include more than one material to deposit. The solution may include predefined relative concentrations of each material to ensure that a predefined electrical output applied by electrodes in the material depositor 102 to the solution causes the deposition of the materials in predefined relative amounts to the target surface. In an implementation, the solution may contain a first predefined relative concentration of a first material and to contain a second predefined relative concentration of a second material different from the first material, and the application adheres the first material and the second material to the target surface in a relative proportion based on the first predefined relative concentration and the second predefined relative concentration.

Further, in multi-solution systems, the time duration of deposition of each solution may be predetermined to distribute predefined relative amounts of materials from each of the solutions (e.g., predefined concentrations of the same or different ionic or strongly polarized materials). In implementations in which the different solutions are sequentially applied to make discrete layers of deposited material, the relative timing of deposition of the materials may be varied in a predefined manner to deposit layers of predefined properties (e.g., layers of a predefined relative or absolute thickness).

In one formulation, a first solution may include one or more of sodium citrate (e.g., at an approximately 35 millimolar concentration), iron sulfate (e.g., at an approximately 15 millimolar concentration), and/or gallium sulfate (e.g., at an approximately 17.5 millimolar concentration). A second solution may include copper sulfate. In implementations, the materials to be deposited within the two solutions (e.g., electrolytic materials such as ions of cobalt and copper) may be deposited on the target surface concurrently or alternatively (e.g., in layers) to form an electroplated giant magnetoresistance structure.

In another formulation, a first solution may include one or more of cobalt sulfate (e.g., at an approximate concentration of 77.5 grams), copper sulfate (e.g., at an approximate concentration of 0.57 grams per liter), and/or boric acid (e.g., at an approximate concentration of 50 grams per liter), and the solution may have an approximate pH of 3.7. A second solution may include copper sulfate. In implementations, the two solutions may be deposited on the target surface concurrently or alternatively (e.g., in layers) to form an electroplated giant magnetoresistance structure.

In another formulation, an electrolyte solution including one or more of cobalt chloride, iron chloride, nickel chloride, nickel sulfate, boric acid, Naphthalene-1,3,6-trisulfonic acid (or an isomer thereof), and/or sulfosalicylic (or an isomer thereof) can be applied. In implementations, this formulation can be used to electroplate a magnetic material composed of cobalt, nickel, and iron. Also, by varying the concentration of each element, the magnetic properties can be modified by depositing different ratios of one or more of the cobalt, nickel, and/or iron.

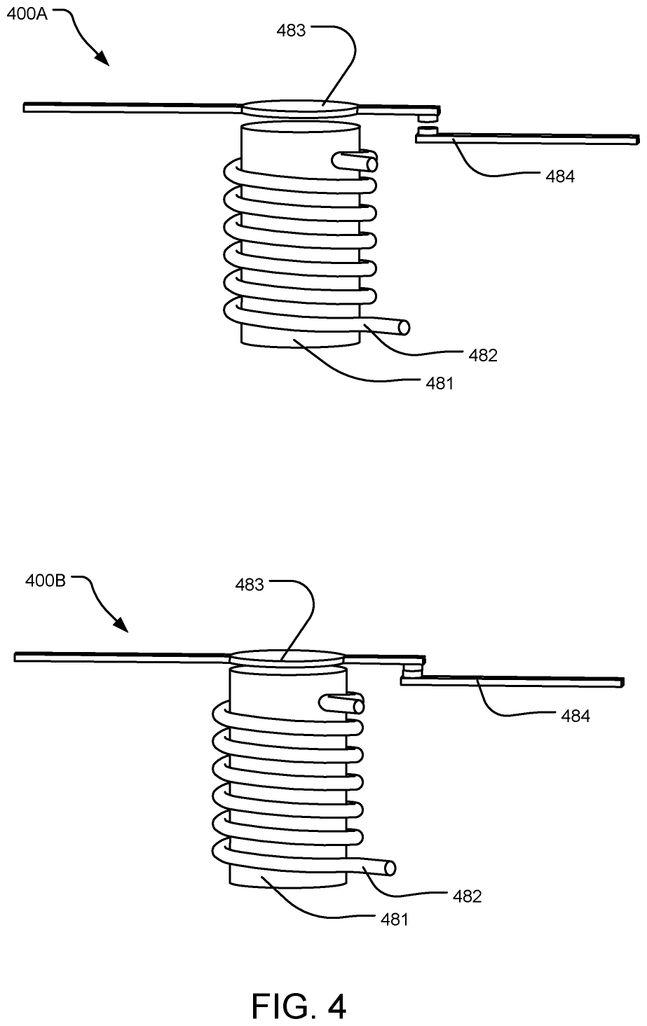

In another formulation, the solution may include various amounts of one or more of copper, silver, iron, and/or nickel. In implementations, this formulation can be used to generate one or more of electrical conductors, thermal conductors, and/or mechanical flexure devices. These elements can be used to precisely print small dynamic circuitry directly onto a target surface that would be more difficult to manufacture by other means. An example of a flexure device that can be manufactured using these formulations is presented in FIG. 4.

In implementations, the object on which the material depositor 102 is to deposit the material does not have an adequate target surface for electroplating (e.g., it is non-conductive). In these implementations, a target surface may be generated by applying a conductive substance to the non-conductive object (e.g., by scuffing up a portion of the object and applying a conductive paste or powder) and/or providing a ground or voltage connection to the conductive substance. Examples of conductive substances include silver-filled resin and poly polystyrene sulfonate-based resins.

In implementations, the additive manufacturing system 100 includes more than one instance of the material depositor 102. For example, each material depositor 102 may be used for different solutions, or the additive manufacturing system includes a different instance of the material depositor 102 (e.g., a conventional one configured to deposit resin, metal, or other material or compound configured for additive manufacturing). Alternatively or additionally, the material depositor 102 may be configured to deposit both materials from solution and more conventional additive manufacturing materials using conventional additive manufacturing methods within the same instance of the material depositor 102 (e.g., within the same three-dimensional print head). In an implementation, elements of a more conventional additive manufacturing deposition mechanism may be within or outside of the hydrophilic region 132.

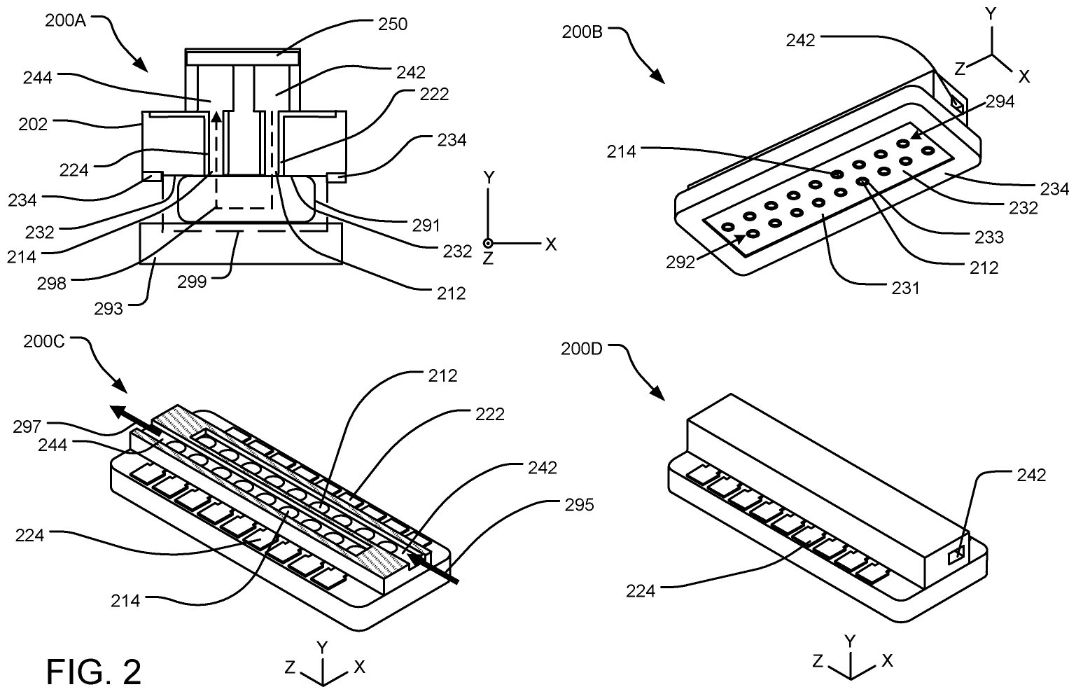

FIG. 2 illustrates an implementation of a material depositor system. Deposition channels 212 are used to deposit source solution in a rich state, and removal channels are used to remove depleted solution in a depleted state. Perspective 200A illustrates a coronal cross-sectional view of an implementation of a material depositor 202. For simplicity, the coronal cross-sectional view is presented as if one of the deposition channels 212 and one of the removal channels 214 are coincident in a single coronal cross-section. It should be appreciated that, as illustrated in perspectives 200B-D, the deposition channels 212 may be staggered relative to the removal channels 214 such that the coronal cross-section would only include one or the other of one of the deposition channels 212 and one of the removal channels 214.

As illustrated by flow direction 298, a solution in a rich state is introduced from a common source feed channel 242 to the deposition channels 212. In the illustrated implementation, the electrodes 222 and 224 include elements that are integral to the deposition channels 212 and the removal channels 214, respectively. The solution is introduced from an outlet of the deposition channels 212 and through a gap 233 in a hydrophilic surface 231 that at least partially defines a hydrophilic region 232. The solution then resides between the material depositor 202 and a target surface 293, onto which material from the solution is to be deposited.

In the illustrated implementation, the solution between the material depositor 202 and the target surface 293 defines a meniscus 291. The meniscus 291 may be maintained at least partially by the capillary action of the solution. The hydrophilic region 232 is substantially circumscribed about its perimeter by a hydrophobic barrier 234. The affinity the hydrophilic region 232 has for the solution (e.g., in a water-based, aqueous solution) and the repulsion by the hydrophobic barrier 234 may combine to help the natural capillary action of the solution to maintain the meniscus 291. The relative configurations of the hydrophilic region 232 and the hydrophobic barrier 234 can ensure that the solution remains within a projection 299 of the hydrophilic region 232 on the target surface 293.

The material depositor activates electrodes 222 and 224 to apply at least one predefined electrical output. The predefined electrical output applied by the electrodes 222 and 224 may cause material from the solution to adhere to the target surface 293 (e.g., electroplating the target surface 293 by generating a potential difference between the target surface 293 and the electrodes 222 and 224). After material from the solution is deposited on the target surface 293, the solution is at least partially depleted of the material and is in a depleted state.

The material depositor 202 then removes the solution in the depleted state from between the material depositor 202 and the target surface 293 and through the removal channels 214 to a common removal channel 244. The solution in the depleted state may then be removed from the common removal channel 244 of material depositor 202 to a disposal reservoir.

In implementations, the material depositor 202 includes a sensor 250. The sensor 250 may be in communication with one or more of a controller of an additive manufacturing device and/or an external computing device. The sensor 250 may be used to determine a position of the material depositor 202 relative to one or more of an element of the additive manufacturing device, the target surface, and/or an element that includes the target surface. The sensor may alternatively or additionally be configured to be used by the controller or computing device to detect one or more of a magnitude, a thickness, a location, an electrical responsiveness, a magnetic responsiveness, a percentage coverage (e.g., relative to the target surface 293), and/or a presence of the material deposited by the material depositor 202 on the target surface 293. In implementations, rather than applying electricity by electrodes over a predefined duration, the sensor 250 may be used in a feedback loop to determine when to stop applying the electrolyte to the target surface 293. Alternatively or additionally (e.g., even in instances where the solution and/or the electricity are applied over predefined durations), the sensor 250 can be used as a quality assurance tool to ensure that the deposition satisfies a predefined quality condition (e.g., based on a magnitude, a thickness, a location, an electrical responsiveness, a magnetic responsiveness, a percentage coverage, and/or a presence of the material deposited by the material depositor on the target surface 293). The sensor 250 may include one or more of a visual sensor, an optical sensor, a sonic sensor, a strain sensor, a magnetic sensor, a capacitative sensor, a contact sensor, a giant magnetoresistance sensor, a camera, and/or the like. In implementations, the sensor 250 transmits and/or receives one or more of electromagnetic radiation and/or vibration through the solution and/or through an element of the material depositor 202. In an implementation, the sensor 250 may be configured to determine or provide data to determine whether a conductive deposited material is likely to cause shorts or arcs by the distribution of the conductive material too close to other conductive material. In another implementation, the sensor 250 can detect the quality of the meniscus 291, allowing the material depositor system to control the pressure applied to the solutions in a feedback loop to maintain the meniscus 291.

In implementations, the sensor 250 may be placed differently from the position illustrated in FIG. 2. For example, the sensor may be placed at a position within the hydrophilic surface 231, at the hydrophobic barrier 234, or at a point in one of the deposition channels 212 or one of the removal channels 214 (e.g., a terminal end where the meniscus is maintained). Placement of the sensor 250 close to the site of the applied solution or target surface 293 may be beneficial for non-optical sensors (e.g., for a magnetic sensor, a capacitive sensor, a contact sensor, or a giant magnetoresistance sensor). Optical sensors may benefit more from the illustrated placement of the sensor 250, as the optical sensors may transmit and/or receive electromagnetic radiation through transparent or translucent solutions (if the solutions are transparent or translucent relative to the frequency of electromagnetic radiation the sensor uses) flowing through the deposition channels 212 and the removal channels 214.

In an implementation, at least one pressure sensor (not illustrated) is placed along the common source feed channel 242 (e.g., at an inlet or at each of the deposition channels 212), and at least one pressure sensor is placed near an outlet of the common removal channel 244 to maintain a predefined solution flow. In implementations, the pressure sensor arrangement can also detect clogged or restricted flow in one or more of the deposition channels 212 and/or the removal channels 214 by detecting a change in the input and output pressure.

Perspective 200B shows an isometric view from a perspective of a bottom surface of the material depositor 202. As illustrated, the hydrophobic barrier 234 entirely circumscribes the perimeter of the hydrophilic region 232. Also, the deposition channels 212 are arranged in a first row 292, and the removal channels 214 are arranged in a second row 294. As illustrated, the first row 292 and the second row 294 are substantially parallel, and the first row 292 and the second row 294 and the deposition channels 212 and removal channels 214 contained therein, respectively, are geometrically staggered relative to one another (e.g., relative to a longitudinal length of the first row 292 and/or the second row 294). Perspective 200C shows a transverse cross-section of the material depositor 202 at the level of the common source feed channel 242 and/or common removal channel 244. An arrow 295 illustrates a source feed flow direction for receiving solution in a rich state in the common source feed channel 242 and distributing the solution in a rich state to the deposition channels 212. An arrow 297 illustrates a removal flow for removing solution in a depleted state from the removal channels 214 to the common removal channel 244 and transporting the removed solution from the material depositor 202. Perspective 200D shows an isometric view of the material depositor 202 from a top perspective.

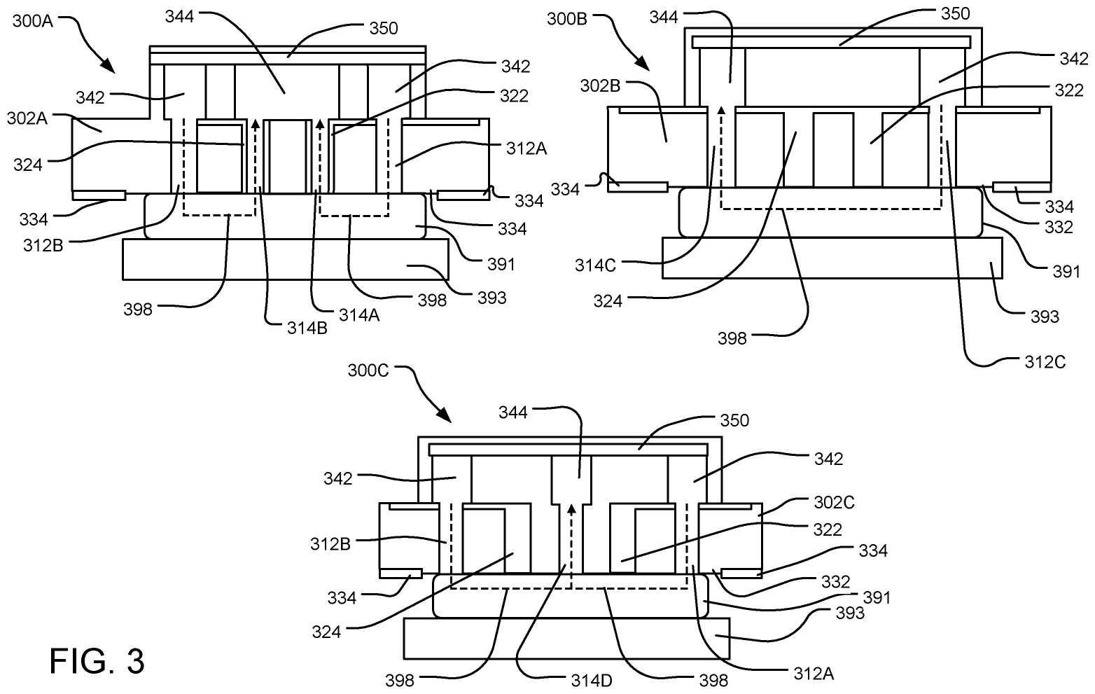

FIG. 3 illustrates cross-sectional perspective views of examples of implementations of material depositors. As in the perspective 200A, material depositor environments 300A-C show coronal cross-sectional views of an implementation of a material depositor. As in perspective 200A, for simplicity, the coronal cross-sectional view is presented as if the deposition channels and the removal channels are coincident in a single coronal cross-section. It should be appreciated that, as illustrated in perspectives 200B-D, the deposition channels may be staggered relative to the removal channels such that the coronal cross-section would only include one or the other of the deposition channels and the removal channels. Further, implementations are also contemplated in which the material depositor includes more than two rows of channels. Also, like-numbered elements from the implementations of FIG. 2 may be implementations of the same in FIG. 3.

A material depositor environment 300A includes a first implementation of a material depositor 302A with deposition channels, including a first deposition channel A and a second deposition channel 312B, and removal channels, including a first removal channel 314A and a second removal channel 314B located medially relative to the deposition channels. The medial location of the removal channels may help to direct the flow 398 of solution medially to a target surface 393, which may help to maintain a meniscus 391. As illustrated, the solution between the material depositor 302A and the target surface 393 defines the meniscus 391. The meniscus 391 may be maintained at least partially by the capillary action of the solution. A hydrophilic region 332 is substantially circumscribed about its perimeter by a hydrophobic barrier 334. In implementations, the material depositor includes a sensor 350. The sensor 350 may be in communication with one or more of a controller of an additive manufacturing device and/or an external computing device (e.g., for feedback control and/or quality assurance, as described herein). As illustrated, the first removal channel 314A and the second removal channel 314B are lined with elements of a first electrode 322 and a second electrode 324, respectively.

As illustrated, the deposition channels share a common source feed channel 342, and the removal channels share a common removal channel 344. Implementations are contemplated in which the deposition channels do not share a common source feed channel 342 but are in fluid communication with different and/or separate instances of the common source feed channel 342 to allow for different solutions to be concurrently or alternatively introduced through the deposition channels. In implementations (e.g., ones where more than one solution is introduced), the first electrode 322 and the second electrode 324 apply different predefined electrical outputs. For example, the first electrode 322 may be closer to the first deposition channel 312A, so the first electrode 322 may apply a predefined electrical output that is more appropriate (predefined based on experimentation) for the deposition of one or more materials in the solution introduced by the first deposition channel 312A. The same or a different predefined relationship may apply to the second deposition channel 312B and the second electrode 324.

A material depositor environment 300B includes a second implementation of a material depositor 302B. In this implementation, the material depositor 302B includes a deposition channel 312C and a removal channel 314C (e.g., one of each). Between the deposition channel 312C and the removal channel 314C, the material depositor includes a first electrode 322 and a second electrode 324 that do not line the interiors of and/or are not integrated with the deposition channel 312C and/or the removal channel 314C, respectively.

A material depositor environment 300C includes a third implementation of a material depositor 302C. In this implementation, the material depositor 302C includes two instances of the deposition channels, illustrated as a first deposition channel 312A and a second deposition channel 312B, and a single medially located instance of a removal channel 314D. The material depositor 302C includes a first electrode 322 between the first deposition channel 312A and the removal channel 314D and includes a second electrode 324 between the second deposition channel 312B and the removal channel 314D. The electrodes may be configured to apply the same predefined electrical output or different predefined electrical outputs. For example, although the material depositor is illustrated as having a single instance of the common source feed channel 342, in implementations each of the first deposition channel 312A and the second deposition channel 312B (e.g., the deposition channels in their respective rows) may be in fluid communication with a dedicated instance of the common source feed channel 342 in fluid communication with different solution sources to provide different solutions. In this implementation, the electrodes may provide different predefined electrical outputs. For example, the first electrode 322 could apply a first predefined electrical output configured to deposit material from a first solution supplied by the first deposition channel 312A adjacent to the first electrode 322. Similarly, the second electrode could apply a second predefined electrical output configured to deposit material from the second solution supplied by the second deposition channel 312B adjacent to the second electrode 324.

FIG. 4 illustrates an example of a magneto-mechanical flexure switch assembly, the components of which may be produced by an additive manufacturing system as disclosed herein. The first switch assembly scenario 400A shows a coil 482 wrapped around a member 481. When current is supplied to the coil 482, a magnetic field is generated and the member 481 is magnetized. In the first switch assembly scenario 400A, no current is supplied to the coil 482, so the member is insufficiently magnetized to attract a first magnetic arm 483. In the first switch assembly scenario 400A, the first magnetic arm remains at a distal position relative to the member 481. In the second switch assembly scenario 400B, a current is supplied to the coil 482, at least further magnetizing the member to satisfy an attraction condition such that the first magnetic arm 483 moves towards the member 481 to a proximal position relative to the member 481. The motion causes the first magnetic arm 483 to establish electrical communication with the second arm 484. This electrical coupling can be decoupled by ceasing the supply of current to the coil 482 and/or by reversing the direction of the current supplied. As such, controlling the current supplied to the coil 482 controls the electrical switch assembly composed of the member 481, the coil 482, the first magnetic arm 483, and the second arm 484.

Any of the member 481, coil 482, first magnetic arm 483, and the second arm 484 can be manufactured using the additive manufacturing systems disclosed herein. The additive manufacturing systems may use a visual, sonic, resistive, magnetic, or magnetoresistive sensor (e.g., a giant magnetoresistive sensor) to determine whether one or more of the member 481, the coil 482, the first magnetic arm 483, and/or the second arm 484 possess appropriate magnetic and/or electrical properties to function in a switch as illustrated. As mentioned, the electrolytic solution deposition systems may be better suited to deposit magnetic materials than systems that rely on sintering metallic powders, as the systems reduce the likelihood of errant deposition and/or adherence. In implementations, an electrolytic solution material depositor can be used that additionally includes conventional additive manufacturing elements to manufacture the more conventional material elements of the magneto-mechanical flexure switch assembly, as described herein.

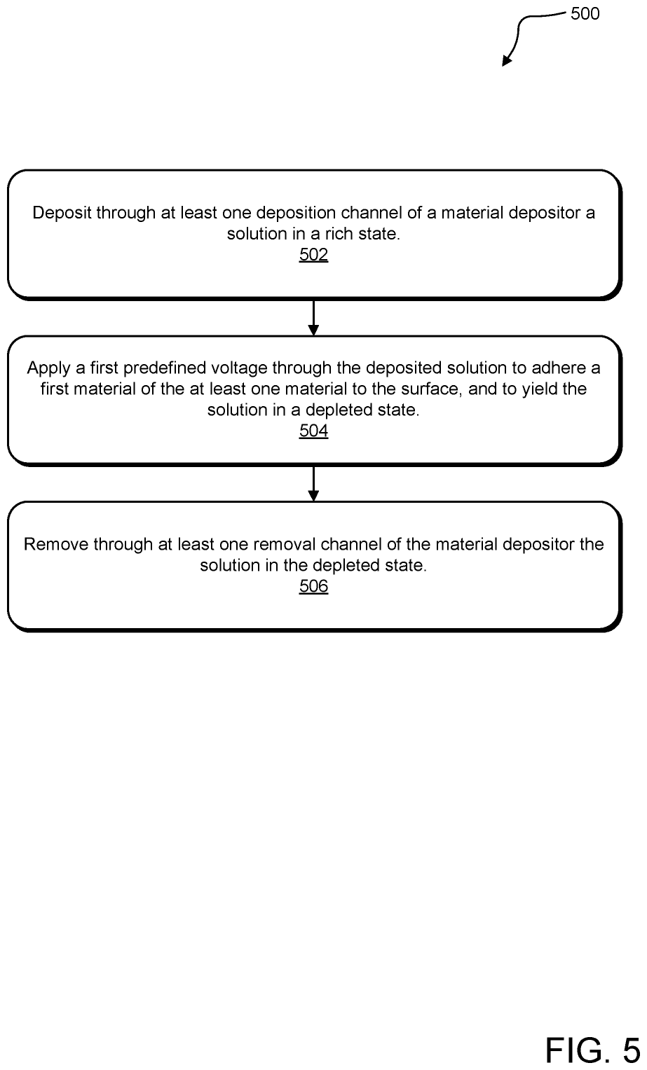

FIG. 5 illustrates example operations 500 for operating an additive manufacturing system. A depositing operation 502 deposits, through at least one deposition channel of a material depositor, the solution in a rich state to the surface, wherein the solution in the rich state includes an initial concentration of the at least one material, onto a surface. The material depositor may, based on instructions from the controller, deposit the solution provided by the first source reservoir onto the target surface. The pressure to transport the solution from the first source reservoir to the material depositor may be provided by a pressure application device (e.g., a pump). In implementations, the deposition channels are fed by a common feed source channel. In implementations in which the material depositor is configured to load more than one solution at a time, the material depositor may include a common source feed channel for each of the solutions. The solution is introduced from an outlet of the deposition channel and through a gap in a hydrophilic surface that at least partially defines a hydrophilic region. The solution then resides between the material depositor and a target surface onto which material from the solution is to be deposited. At this stage, the solution may be in an initial rich state in which no material has yet been removed from the solution.

The solution between the material depositor and the target surface may define a meniscus. The meniscus may be maintained at least partially by the capillary action of the solution. The affinity the hydrophilic region has for the solution (e.g., because it is a water-based aqueous solution) and the repulsion by the hydrophobic region may combine to help the natural capillary action of the solution maintain the meniscus. The relative configurations of the hydrophilic region and the hydrophobic region can ensure that the deposited solution remains within a projection of the hydrophilic region on the target surface.

An application operation 504 applies a first predefined electrical output, by the material depositor, through the deposited solution to adhere a first material of the at least one material to the surface. The application operation 504 yields the solution in a depleted state in which the deposited solution includes a second concentration of the at least one material from the rich solution, the second concentration being different from (e.g., less than) the initial concentration.

One or more electrodes of the material depositor may apply a predefined electrical output to the solution while the solution is engaged with the target surface. The target surface may be provided with an electrical potential (or ground) that is different from the potential provided by the predefined electrical output applied by the one or more electrodes. The potential difference may cause some of the material from the solution to deposit on the target surface, at least partially depleting the solution of the material deposited.

Implementations are considered in which the one or more electrodes may be adapted to apply more than one predefined electrical output. For example, the material depositor may dispense a solution with more than one electrolyte and the relative deposition of each of the more than one can be controlled by the predefined electrical outputs applied. For example, in a solution with materials (e.g., electrolytes) A and B, applying a first predefined electrical output may deposit more A than B (or substantially no B at all) to a target surface, but applying a second predefined electrical output may deposit more B than A (or substantially no A at all) on a target surface. In implementations, the material depositor may be capable of receiving and separately dispensing through different deposition channels and/or at different times more than one solution, and/or electrodes of the material depositor may be configured to apply different predefined electrical outputs to each of the solutions (e.g., by applying different predefined electrical outputs to electrodes adjacent to deposition channels that deposit the different solutions). The different predefined electrical outputs may also be applied for different durations depending on the kinetics of the additive manufacturing system.

In implementations, the material depositor includes a hydrophilic region at least partially defined by a hydrophilic surface with gaps at outlets of the deposition channels and the removal channels and further includes a hydrophobic barrier that substantially circumscribes the hydrophilic region.

A removing operation 506 removes through at least one removal channel in the material depositor, the deposited solution in the depleted state. The material depositor may remove the solution in a depleted state via a removal channel in the material depositor. The deposition and removal may be conducted in a preconfigured manner (e.g., predefined pressures applied to channels within the material depositor) to ensure that a meniscus of the solution is maintained between the material depositor and the target surface. Predefined pressures to be applied to the solution in the additive manufacturing system may be determined based on one or more of a predefined cohesion of the solution, a geometry of flow path for the solution through the material depositor, a predefined residence time for the solution on a hydrophilic surface, a predefined potential application duration, and/or a predefined distance between one of the at least one deposition channel and one of the at least one removal channel. Portions of the deposition and removal processes may be conducted continuously and/or discretely.

The solution may be preformulated to include more than one material to deposit. The solution may include predefined relative concentrations of each material to ensure that a predefined electrical output applied by electrodes in the material depositor to the solution causes the deposition of the materials in predefined relative amounts to the target surface. Further, in multi-solution systems, the time of deposition of each solution may be predetermined to distribute relative amounts of materials from each of the solutions. In implementations in which the different solutions are sequentially applied to make discrete layers of deposited material, the relative timing of deposition of the materials may be varied in a predefined manner to deposit layers of predefined properties (e.g., layers of a predefined relative or absolute thickness). Sequential applications of different solutions may require a flushing step between uses of the different solutions to purge the prior solution.

In one formulation, a first solution may include one or more of sodium citrate (e.g., at an approximately 35 millimolar concentration), iron sulfate (e.g., at an approximately 15 millimolar concentration), or gallium sulfate (e.g., at an approximately 17.5 millimolar concentration). A second solution may include copper sulfate. The two solutions may be deposited on the target surface concurrently or alternatively (e.g., in layers) to form an electroplated giant magnetoresistance structure.

In another formulation, a first solution may include one or more of cobalt sulfate (e.g., at an approximate concentration of 77.5 grams), copper sulfate (e.g., at an approximate concentration of 0.57 grams per liter), or boric acid (e.g., at an approximate concentration of 50 grams per liter), and the solution may have an approximate pH of 3.7. A second solution may include copper sulfate. The materials to be deposited in the two solutions may be deposited on the target surface concurrently or alternatively (e.g., in layers) to form an electroplated giant magnetoresistance structure.

In another formulation, an electrolyte solution including one or more of cobalt chloride, iron chloride, nickel chloride, nickel sulfate, boric acid, Naphthalene-1,3,6-trisulfonic acid (or an isomer thereof), or sulfosalicylic (or an isomer thereof) can be applied. This formulation can be used to electroplate a magnetic material composed of cobalt, nickel, and iron. Also, by varying the concentration of each element, the magnetic properties can be modified by depositing different ratios of one or more of the cobalt, nickel, or iron.

In another formulation, the solution may include various amounts of one or more of copper, silver, iron, or nickel. This formulation can be used to generate one or more of electrical conductors, thermal conductors, or mechanical flexure devices. These elements can be used to precisely print small dynamic circuitry directly onto a target surface that would be difficult to manufacture by other means. An example of a flexure device that can be manufactured using these formulations is presented in FIG. 4.

In implementations, the object on which the material depositor is to deposit the material does not have an adequate target surface for electroplating (e.g., it is non-conductive). In these implementations, a target surface may be generated by applying a conductive substance to the non-conductive object (e.g., by scuffing up a portion of the object and applying a conductive paste or powder) and providing a ground or voltage connection to the conductive substance. Examples of conductive substances include silver-filled resin and poly polystyrene sulfonate-based resins.

In implementations, the additive manufacturing system includes more than one material distributor. For example, each material distributor may be used for different solutions, or the additive manufacturing system may include a different material distributor (e.g., one configured to deposit resins as is known in the art). Alternatively or additionally, the material distributor may be configured to deposit both materials from solution more conventional additive manufacturing materials such as resin using conventional additive manufacturing methods within the same material distributor (e.g., within the same three-dimensional print head).

In implementations, the material depositor includes a sensor. The sensor may be in communication with one or more of a controller of an additive manufacturing device or an external computing device. The sensor may be used to determine a position of the material depositor relative to one or more of an element of the additive manufacturing device, the target surface, or an element that includes the target surface. The sensor may alternatively or additionally be configured to be used by the controller or computing device to detect one or more of a presence or magnitude of the deposited material deposited on the target surface. The sensor may include one or more of a visual sensor, a sonic sensor, a strain sensor, a magnetic sensor, a giant magnetoresistance sensor, or the like. In implementations, the sensor transmits and/or receives one or more of electromagnetic radiation and vibration through the solution and/or through an element of the material depositor.

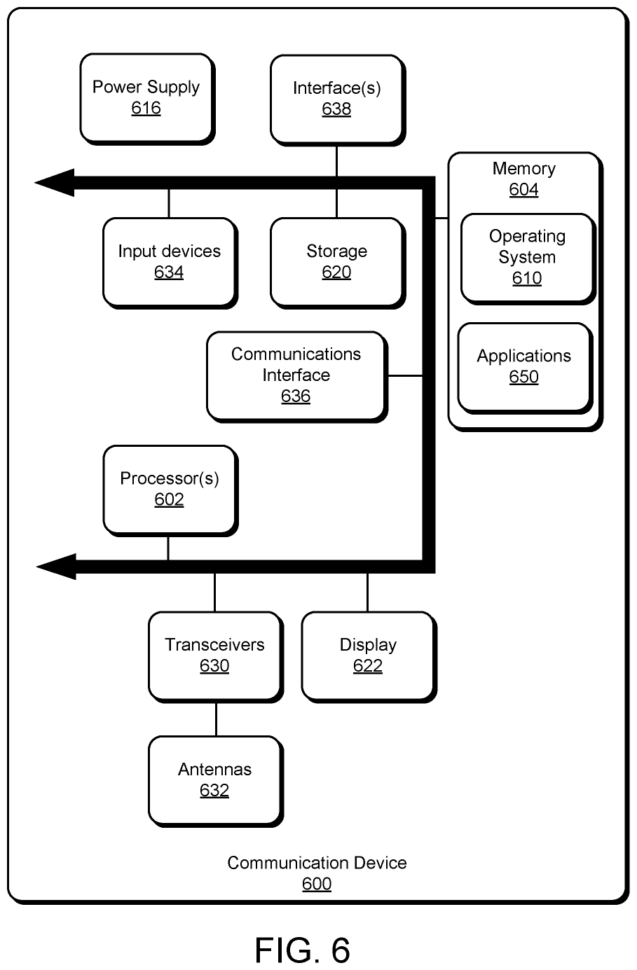

FIG. 6 illustrates an example computing device 600 for implementing the features and operations of the described technology. The computing device 600 may embody a remote-control device or a physically controlled device or may be an example network-connected and/or network-capable device or may be a client device, such as a laptop, mobile device, desktop, tablet; a server/cloud device; an internet-of-things device; an electronic accessory; or another electronic device. The computing device 600 includes one or more processor(s) 602 and a memory 604. The memory 604 generally includes both volatile memory (e.g., RAM) and nonvolatile memory (e.g., flash memory). An operating system 610 resides in the memory 604 and is executed by the processor(s) 602. The computing device 600 may be an implementation of one or more of the controller 182 or the computing device 104.

In an example computing device 600, as shown in FIG. 6, one or more modules or segments, such as applications 650 and additive manufacturing control protocols are loaded into the operating system 610 on the memory 604 and/or storage 620 and executed by processor(s) 602. The storage 620 may include one or more tangible storage media devices and may store predefined durations of application, predefined concentrations, predefined pressures, predefined electrical output, predefined relative concentrations of materials in solution, data output from additive manufacturing systems, instructions representing additive manufacturing operations disclosed herein, locally and globally unique identifiers, requests, responses, and other data and be local to the computing device 600 or may be remote and communicatively connected to the computing device 600.

The computing device 600 includes a power supply 616, which is powered by one or more batteries or other power sources and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers and/or client devices (e.g., mobile devices, desktop computers, or laptop computers). The computing device 600 may further include a communications interface 636 (e.g., a network adapter), which is a type of computing device. The computing device 600 may use the communications interface 636 and any other types of computing devices for establishing connections over a wide-area network (WAN) or local-area network (LAN). It should be appreciated that the network connections shown are examples and that other computing devices and means for establishing a communications link between the computing device 600 and other devices may be used.

The computing device 600 may include one or more input devices 634 such that a user may enter commands and information (e.g., a keyboard or mouse). These and other input devices may be coupled to the server by one or more interfaces 638, such as a serial port interface, parallel port, or universal serial bus (USB). The computing device 600 may further include a display 622, such as a touch screen display.

The computing device 600 may include a variety of tangible processor-readable storage media and intangible processor-readable communication signals. Tangible processor-readable storage can be embodied by any available media that can be accessed by the computing device 600 and includes both volatile and nonvolatile storage media, removable and non-removable storage media. Tangible processor-readable storage media excludes communications signals (e.g., signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of a remote-control device and/or a physically controlled device implemented to perform a particular function. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across one or multiple user sessions. A service may be available to one or more system components, programs, and/or other services. In some implementations, a service may run on one or more server computing devices.

The logical operations making up implementations of the technology described herein may be referred to variously as operations, steps, objects, or modules. Furthermore, it should be understood that logical operations may be performed in any order, adding or omitting operations as desired, regardless of whether operations are labeled or identified as optional, unless explicitly claimed otherwise or a specific order is inherently necessitated by the claim language. The operations may be combined to assemble methods.

An example method is provided, comprising: depositing, through at least one deposition channel of a material depositor, a solution in a rich state to a target surface, wherein the solution in the rich state includes an initial concentration of at least one material; applying a first predefined electrical output, by the material depositor, through the solution to adhere a first material of the at least one material to the target surface, and to yield the solution in a depleted state wherein the solution in the depleted state contains a second concentration of the at least one material in the solution, the second concentration being different from the initial concentration; and removing, through at least one removal channel in the material depositor, the solution in the depleted state, wherein the material depositor includes: a hydrophilic region including a hydrophilic surface including gaps through which the material depositor conducts the depositing and the removing; and a hydrophobic barrier at least partially circumscribing the hydrophilic region.

Another example method of any herein described method or operations is provided, wherein the solution is maintained within a projection of the hydrophilic region between the depositing and the removing.

Another example method of any herein described method or operations is provided, wherein one or more of the depositing and the removing are conducted by applying a predefined pressure to the solution.

Another example method of any herein described method or operations is provided, wherein the predefined pressure is based on one or more of a predefined cohesion of the solution, a geometry of flow path for the solution through the material depositor, a predefined residence time for the solution on the target surface, a predefined potential application duration, or a predefined distance between one of the at least one deposition channel and one of the at least one removal channel.

Another example method of any herein described method or operations is provided, further comprising: maintaining a meniscus between the material depositor and the target surface.

Another example method of any herein described method or operations is provided, wherein the at least one deposition channel are arranged in a first row and the at least one removal channel are arranged in a second row, wherein the first row is geometrically staggered relative to the second row.

Another example method of any herein described method or operations is provided, further comprising: applying a second predefined electrical output different from the first predefined electrical output, by the material depositor, through the solution to adhere a second material of the at least one material to the target surface.

Another example method of any herein described method or operations is provided, wherein the applying of the first predefined electrical output occurs over a first duration and the applying of the second predefined electrical output occurs over a second duration, the first duration at least partially different from the second duration.

Another example method of any herein described method or operations is provided, further comprising: formulating the solution to contain a first predefined relative concentration of the material of the at least one material and to contain a second predefined relative concentration of a second material of the at least one material different from the first material, wherein the applying adheres the first material and the second material to the target surface in a relative proportion based on the first predefined relative concentration and the second predefined relative concentration.

An example additive manufacturing system for depositing at least one material from a solution is provided, comprising: a material depositor, comprising: at least one deposition channel through which the material depositor is adapted to deposit the solution in a rich state to a target surface, wherein the solution in the rich state includes an initial concentration of the at least one material; at least one electrode adapted to apply a first predefined electrical output through the solution to adhere the at least one material to the target surface and to yield the solution in a depleted state, wherein the solution in the depleted state contains a second concentration of the at least one material in the solution, the second concentration being different from the initial concentration; at least one removal channel through which the material depositor is adapted to remove the solution in the depleted state; a hydrophilic region including a hydrophilic surface including gaps through which the material depositor conducts the deposition and the removal; and a hydrophobic barrier that substantially circumscribes the hydrophilic region.

Another example additive manufacturing system of any herein described system is provided, wherein the hydrophobic barrier is adapted to maintain the solution within a projection of the hydrophilic region between the deposition and the removal.

Another example additive manufacturing system of any herein described system is provided, further comprising: a pressure application device to apply a predefined pressure to the solution to facilitate one or more of the deposition and the removal, wherein the predefined pressure is based on one or more of a predefined cohesion of the solution, a geometry of flow path for the solution through the material depositor, a predefined residence time for the solution on the hydrophilic surface, a predefined potential application duration, or a predefined distance between one of the at least one deposition channel and one of the at least one removal channel.

Another example additive manufacturing system of any herein described system is provided, wherein the at least one deposition channel comprises: one or more first source deposition channels adapted to be in fluid communication with and receive the solution from a first source; and one or more second source deposition channels adapted to be in fluid communication with and receive a second solution different from the first solution from a second source, wherein the one or more first source deposition channels are not in direct fluid communication with the one or more second source deposition channels within the material depositor.

Another example additive manufacturing system of any herein described system is provided, wherein the at least one deposition channel are arranged in a first row within the hydrophilic region and the at least one removal channel are arranged in a second row within the hydrophilic region, wherein the at least one deposition channel in the first row is geometrically staggered relative to the at least one removal channel in the second row along a longitudinal length of the first row.

Another example additive manufacturing system of any herein described system is provided, the at least one electrode further adapted to apply a second predefined electrical output different from the first predefined electrical output through the solution to adhere a second material of the at least one material to the target surface.

Another example additive manufacturing system of any herein described system is provided, further comprising: a first reservoir adapted to provide the solution to the material depositor; a second reservoir adapted to provide a second solution different from the solution to the material depositor; and a controller configured to control deposition of the solution and the second solution by the material depositor.

Another example additive manufacturing system of any herein described system is provided, wherein the at least one electrode applies the first predefined electrical output through one or more of the at least one deposition channel and the at least one removal channel.

Another example additive manufacturing system of any herein described system is provided, wherein the at least one electrode applies the first predefined electrical output at a position between the at least one deposition channel and the at least one removal channel.

Another example additive manufacturing system of any herein described system is provided, further comprising: an optical sensor to detect one or more of position of the material depositor and a magnitude of the at least one material deposited.

Another example additive manufacturing system of any herein described system is provided, the material depositor is a three-dimensional print head, the material depositor further comprising: a common removal channel in fluid communication with the at least one removal channel, the common removal channel adapted to collect the solution removed from the target surface by the material depositor and output the collected solution from the material depositor.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Thus, particular implementations of the subject matter have been described. Other implementations are within the scope of the following claims. Nevertheless, it will be understood that various modifications can be made without departing from the spirit and scope of the recited claims.

As used herein, terms such as “substantially,” “about,” “approximately,” or other terms of relative degree are interpreted as a person skilled in the art would interpret the terms and/or amount to a magnitude of variability of one or more of 1%, 2%, 3%, 4%, 5%, 6%, 7%, 8%, 9%, 10%, 11%, 12%, 13%, 14%, or 15% of a metric relative to the quantitative or qualitative feature described (e.g., as an alternative or supplement to definitions explicitly provided for terms of degree herein). For example, a term of relative degree applied to orthogonality suggests an angle may have a magnitude of variability relative to a right angle. When values are presented herein for particular features and/or a magnitude of variability, ranges above, ranges below, and ranges between the values are contemplated.

What is claimed is:

1. A method, comprising:
depositing, through at least one deposition channel of a material depositor, a solution in a rich state to a target surface, wherein the solution in the rich state includes an initial concentration of at least one material;
applying a first predefined electrical output, by the material depositor, through the solution to adhere a first material of the at least one material to the target surface, and to yield the solution in a depleted state wherein the solution in the depleted state contains a second concentration of the at least one material in the solution, the second concentration being different from the initial concentration; and
removing, through at least one removal channel in the material depositor, the solution in the depleted state,
wherein the material depositor includes:
a hydrophilic region including a hydrophilic surface including gaps through which the material depositor conducts the depositing and the removing; and
a hydrophobic barrier at least partially circumscribing the hydrophilic region.

2. The method of claim 1, wherein the solution is maintained within a projection of the hydrophilic region between the depositing and the removing.

3. The method of claim 1, wherein one or more of the depositing and the removing are conducted by applying a predefined pressure to the solution.

4. The method of claim 3, wherein the predefined pressure is based on one or more of a predefined cohesion of the solution, a geometry of flow path for the solution through the material depositor, a predefined residence time for the solution on the target surface, a predefined potential application duration, or a predefined distance between one of the at least one deposition channel and one of the at least one removal channel.

5. The method of claim 1, further comprising:
maintaining a meniscus between the material depositor and the target surface.

6. The method of claim 1, wherein the at least one deposition channel are arranged in a first row and the at least one removal channel are arranged in a second row, wherein the first row is geometrically staggered relative to the second row.

7. The method of claim 1, further comprising:
applying a second predefined electrical output different from the first predefined electrical output, by the material depositor, through the solution to adhere a second material of the at least one material to the target surface.

8. The method of claim 7, wherein the applying of the first predefined electrical output occurs over a first duration and the applying of the second predefined electrical output occurs over a second duration, the first duration at least partially different from the second duration.

9. The method of claim 1, further comprising:
formulating the solution to contain a first predefined relative concentration of the material of the at least one material and to contain a second predefined relative concentration of a second material of the at least one material different from the first material, wherein the applying adheres the first material and the second material to the target surface in a relative proportion based on the first predefined relative concentration and the second predefined relative concentration.

10. An additive manufacturing system for depositing at least one material from a solution, comprising:
a material depositor, comprising:
at least one deposition channel through which the material depositor is adapted to deposit the solution in a rich state to a target surface, wherein the solution in the rich state includes an initial concentration of the at least one material;
at least one electrode adapted to apply a first predefined electrical output through the solution to adhere the at least one material to the target surface and to yield the solution in a depleted state, wherein the solution in the depleted state contains a second concentration of the at least one material in the solution, the second concentration being different from the initial concentration;
at least one removal channel through which the material depositor is adapted to remove the solution in the depleted state;
a hydrophilic region including a hydrophilic surface including gaps through which the material depositor conducts the deposition and the removal; and
a hydrophobic barrier that substantially circumscribes the hydrophilic region.

11. The additive manufacturing system of claim 10, wherein the hydrophobic barrier is adapted to maintain the solution within a projection of the hydrophilic region between the deposition and the removal.

12. The additive manufacturing system of claim 10, further comprising:
a pressure application device to apply a predefined pressure to the solution to facilitate one or more of the deposition and the removal, wherein the predefined pressure is based on one or more of a predefined cohesion of the solution, a geometry of flow path for the solution through the material depositor, a predefined residence time for the solution on the hydrophilic surface, a predefined potential application duration, or a predefined distance between one of the at least one deposition channel and one of the at least one removal channel.

13. The additive manufacturing system of claim 12, wherein the at least one deposition channel comprises:
one or more first source deposition channels adapted to be in fluid communication with and receive the solution from a first source; and
one or more second source deposition channels adapted to be in fluid communication with and receive a second solution different from the first solution from a second source, wherein the one or more first source deposition channels are not in direct fluid communication with the one or more second source deposition channels within the material depositor.

14. The additive manufacturing system of claim 10, wherein the at least one deposition channel are arranged in a first row within the hydrophilic region and the at least one removal channel are arranged in a second row within the hydrophilic region, wherein the at least one deposition channel in the first row is geometrically staggered relative to the at least one removal channel in the second row along a longitudinal length of the first row.

15. The additive manufacturing system of claim 10, the at least one electrode further adapted to apply a second predefined electrical output different from the first predefined electrical output through the solution to adhere a second material of the at least one material to the target surface.

16. The additive manufacturing system of claim 10, further comprising:
a first reservoir adapted to provide the solution to the material depositor;
a second reservoir adapted to provide a second solution different from the solution to the material depositor; and
a controller configured to control deposition of the solution and the second solution by the material depositor.

17. The additive manufacturing system of claim 10, wherein the at least one electrode applies the first predefined electrical output through one or more of the at least one deposition channel and the at least one removal channel.

18. The additive manufacturing system of claim 10, wherein the at least one electrode applies the first predefined electrical output at a position between the at least one deposition channel and the at least one removal channel.

19. The additive manufacturing system of claim 10, further comprising:
an optical sensor to detect one or more of position of the material depositor and a magnitude of the at least one material deposited.

20. The additive manufacturing system of claim 10, the material depositor is a three-dimensional print head, the material depositor further comprising:
a common removal channel in fluid communication with the at least one removal channel, the common removal channel adapted to collect the solution removed from the target surface by the material depositor and output the collected solution from the material depositor.
